(19) United States
(12) Patent Application Publication
(10) Pub. No.: US 2015/0006546 A1
(43) Pub. Date: Jan. 1, 2015

(54) SYSTEM AND METHOD FOR EVALUATING AND IMPROVING SOCIAL RELATIONSHIPS

(71) Applicant: Maurizio Tripi, Trevi (PG) (IT)

(72) Inventor: Maurizio Tripi, Trevi (PG) (IT)

(21) Appl. No.: 14/318,580

(22) Filed: Jun. 28, 2014

Related U.S. Application Data
(60) Provisional application No. 61/841,185, filed on Jun. 28, 2013.

(51) Int. Cl. G06F 17/30; G06F 3/0482

(52) U.S. Cl. CPC G06F 17/3089; G06F 3/0482
USPC 707/748

(57) ABSTRACT

A system, device and method to evaluate and improve relationships. The system, device and method helps users evaluate their relationships with reduced emotional and personal bias. Users can also see how other users see the relationship with them, moreover users can get a score on their social skills and advice to improve them.

### CROSS-REFERENCE TO RELATED APPLICATIONS

This application claims the benefit of U.S. Provisional Application No. 61/841,185, filed Jun. 28, 2013 and entitled “System And Method For Evaluating And Improving Social Relationships”, hereby incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of relationship management systems.

More particularly, the present invention is in the technical field of real-life relationship management and improvement through the Internet and cloud connected portable devices and systems.

Social relationships are an important part of people's lives because they are means of fundamental human needs like social acceptance, love, family or group belonging, reputation, respect, empathic emotions, friendship and so on. Human beings are, historically and by their own nature, used to establishing social relationships through a personal, face-to-face interaction, as this conveys many different subtle stimuli that make a relationship deeper and comprehensive.

Many different social networks are available on the Web today and many different approaches have been discussed to improve the way people interact. Most of the available methods are based on virtual connections: that is connections (as friend, colleague, relative, just to name a few) made on the Internet and do not necessarily have a real-life counterpart. As a consequence users of those social networks may have hundreds or thousands connections without ever having a real-life relationship with the people in their network. While having a large virtual network of people can be somewhat beneficial to a user, it is of little value for improving their real-life relationships.

Another aspect of social networks approach is that usually comments or evaluations are made about people on the network and not about relationships with them. Moreover users know that their comments are public so they are very attentive to be polite in their comments to not offend people in their social network. This makes any evaluation made on the social network of little relevance for real-life relationships because they don't match with what users really think about their real relationships. Even when comments accurately correspond to what users think, the way the comments are expressed is biased by the commenter's emotions because the comments are about people they know and love.

From the above considerations follow that current social networks are not useful for understanding and improving social relationships but are useful only for establishing new connections.

### SUMMARY OF THE INVENTION

The present invention is a method and system for improving real-life relationships. In particular the present invention is directed to how a user can objectively evaluate and better understand real-life relationships by comparing the user's relationship evaluations with those of their friends, receiving a score about the user's social skills, and suggestions to improve the user's social relationships.

A user can store all known contacts on a device for managing and interacting with contacts i.e. phone calls, emails or other communication systems. This contact list can include hand inputted contacts and contacts synchronized with other personal devices (e.g. personal computer or other smart phones) and web services, for example but not limited to other social networks or cloud services. Every time the user meets a person from the contact list, the user may wish to record a meeting note in which specific information about the meeting are stored with a meeting evaluation. Specifically a meeting evaluation is made by the user rating topics that are relevant to the meeting. The set of topics from which the user can choose is called “value system” and it is comprised of a set of topics that matter to the user; these topics are common to all the user's relationships. If a topic has been discussed during a meeting in a meaningful way and it is part of the user's value system then it contributes to build the value of the relationship with the contact with which the user has met.

Evaluations of all meetings with the same contact are cumulatively added to make the evaluation of the relationship with that contact. An evaluation will be comprised of a general rating and a set of average ratings of all topics discussed in all meetings with the contact. The average rating for the topic discussed can be calculated on the basis of different weights and statistical information like number of meetings, minimum rating, maximum rating, and ratings' variance for the topic discussed. This contact's relationship evaluation gives the user an objective picture of the importance of the meetings with that contact.

Two or more users can join each other through the system and subsequently they can share their respective evaluations. For preserving privacy users may wish to share their evaluation anonymously and the system will show the content of the anonymous evaluations only if there are a sufficient number of anonymous evaluations so that the user would not be able to discern which evaluation is linked to a specific contact (for example this number can be 5). The evaluation sharing can be implemented as a transparent upload on a system connected to the Internet or a cloud service, every time a user updates an evaluation about one of the joined contacts. In a similar way users receive from the same cloud service updates about relevant evaluations. This evaluation sharing mechanism lets a user review how joined contacts privately evaluate the relationship with the user without exposing the contacts' names thus preserving privacy and good relations. Moreover a user can see for every joined contact how friends of the joined contact anonymously evaluate the relationship with that contact. Thus the user and the system can compare the evaluation by the user with the evaluations made by other friends of the same joined contact, deducing possible actions to improve the relationship with that joined contact.

The system can analyze the evaluations shared on the cloud service and meeting dynamics (e.g. meeting frequency) of each user and calculate a score of the social skills of each user and a list of possible actions the user can do to improve the score. This score and the suggested actions are visible to the user on the mobile device and the user can share the achieved score on other social networks as a reputation status.

### BRIEF DESCRIPTION OF THE DRAWINGS

FIG. 1 is a schematic view of an illustrative interface showing the relationship with a user's contact in accordance with one embodiment of the invention;

FIG. 2 is an illustrative description of the process of creating a new meeting note in accordance with one embodiment of the invention;

FIG. 3 is a schematic view of an illustrative interface showing the recording of a meeting note of the user with a contact in accordance with one embodiment of the invention;

FIG. 4 is an illustrative flowchart of the algorithm for evaluating a meeting note and for adding new topics to the list of topics defined by the user in accordance with one embodiment of the invention;

FIG. 5 is an illustrative interface for the evaluation of a meeting as described by the algorithm shown in FIG. 4 in accordance with one embodiment of the invention;

FIG. 6 is an illustrative description of the records needed for saving a meeting note with the evaluations about a specific meeting, and for updating a relationship evaluation in accordance with one embodiment of the invention;

FIG. 7 is a schematic view of an illustrative communication system including two portable electronic devices, a personal computer and a remote server with a database system in accordance with one embodiment of the invention;

FIG. 8 is an illustrative schematic description of the records used for storing relationship evaluations in accordance with one embodiment of the invention;

FIG. 9 is a schematic view of an illustrative display of an interface showing an evaluation about a relationship in accordance with one embodiment of the invention;

FIG. 10 is a schematic view of an illustrative display of an interface for showing the list of all evaluations made by other users about a user's contact in accordance with one embodiment of the invention;

FIG. 11 is a schematic view of an interface showing the details of an evaluation made by other users about a user's contact in accordance with one embodiment of the invention;

FIG. 12 is a schematic view of an interface showing the overview of the user relationships and a rating of the user's social skills in accordance with one embodiment of the invention;

FIG. 13 shows an example of an illustrative directed graph including nodes representing users and directed arcs representing evaluations in accordance with one embodiment of the invention.

### DETAILED DESCRIPTION OF THE INVENTION

The present invention is a method, device and system to improve real-life personal relationships. In particular the present invention is directed to how users can objectively evaluate and better understand real-life relationships by comparing relationship evaluations with those of their friends, receiving a score about their social skills, and reviewing suggestions to improve their social relationships.

A user can use a personal device or a networked service to store and access contact information about relatives, friends, colleagues or other kinds of relationships: this list of contacts known to the user may be referenced as the user's contact list. The user can in part manually enter the user's contact list and other parts could be synchronized with other Internet services or social networks in which the user can be member of. Regardless of the sources of the user's contact list it can be assumed that every relationship important to the user should be in the user's contact list for the user to interact with the contact, for example, by phone call, by email or by means of other communication systems.

A user can access these contacts by storing them on a portable device, a personal computer or other kinds of electronic devices able to store and display information about contacts. In another embodiment a user can use a portable device or a personal computer or other kinds of network connected electronic devices for accessing contacts information stored on a remote host connected to a communication network. The system in every possible embodiment would be able to access the user's contact list and every contact's relationship managed by the present system may be related to an item of the user's contact list.

An exemplary embodiment of the present invention may be implemented as a portable device application connected through the Internet to a remote host with a logically centralized database that is part of the system. Every user may use one personal portable device with information specific to the user. In other embodiments users may use the system implemented as a web application accessible through every kind of electronic device (e.g. personal computers, laptops computer, mobile devices, Smartphones or other devices).

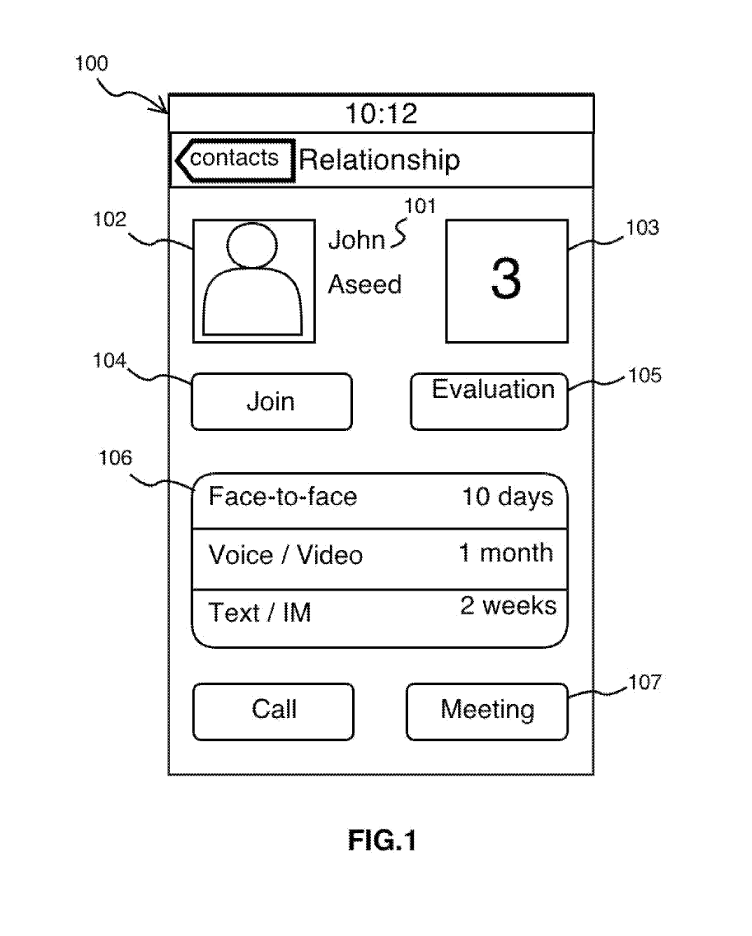

In one exemplary embodiment the user may use the present system on a personal mobile device. FIG. 1 shows a schematic view of an illustrative display of interface 100 describing information about the relationship of the user with a specific contact in accordance with one embodiment of the invention. Interface 100 may appear when the user selects a contact from the user's contact list. Interface 100 may display the name of contact 101 and a picture of contact 102 if present in the contact list.

Icon 103 shows, in a symbolic manner, the balance of the relationship between the user and the contact. The relationship balance can have several values, be they symbolic or numeric. A numeric value is used for simplicity in the present exemplary embodiment.

The value of the balance shown on icon 103 is best when both parties of the relationship keep in touch with the other party, in this case the number will be 0; it is good when the user invites the other contact more frequently, in this case the number would be positive; and it is bad when the other contact invites the user more frequently in this case the number would be negative. The frequency may be calculated on the last N meetings between the user and the contact. The number N can be fixed or in another exemplary embodiment it may be variable with other values, as an example it could change with the number of meetings between the user and the contact that occurred during the past year. According to the present exemplary embodiment if the user has always invited the contact for a meeting for the last N times, the value shown in icon 103 will be N, if the contact has always invited the user for the last N times the value would be −N, and if the user and the contact invited each other an equal number of times over the last N meetings the value would be 0. In other embodiments of the present invention the relationship balance could be a symbol that shows the user the options described above.

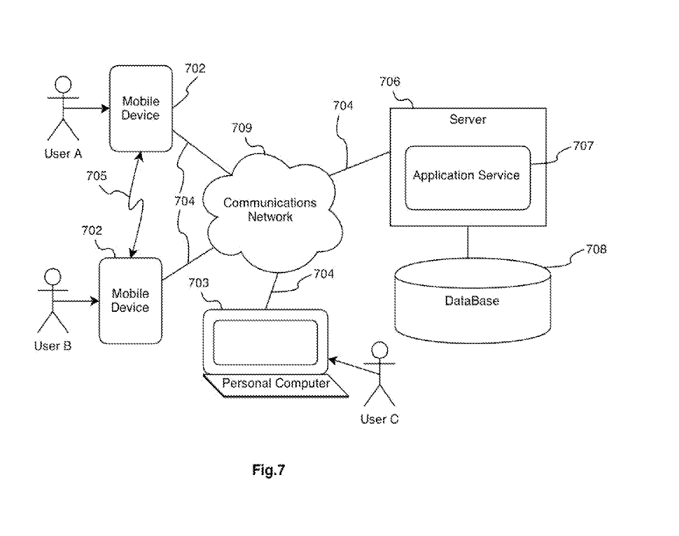

When the user presses the button 104 the system starts the joining procedure that will be described later when explaining FIG. 7. If the user has already joined the contact shown in interface 100, button 104 will display the label “Joined” instead of “Join”. Pushing button 104 will end the joined status of the user with the contact as explained in FIG. 7.

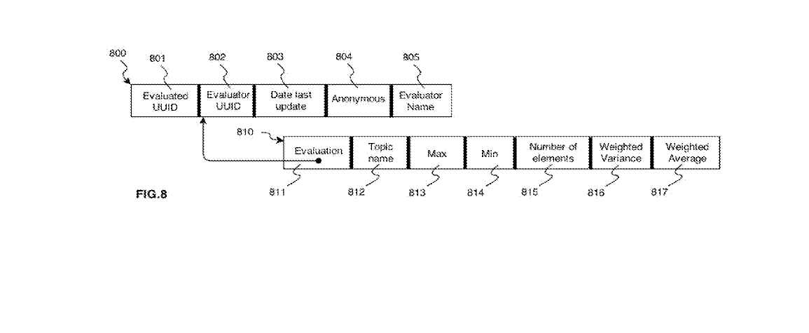

In the present exemplary embodiment, button 105 when pressed may display an interface showing the relationship evaluation about the contact as shown in FIG. 8

Table 106 shows how long ago in the past the last registered meetings with the contact happened in each of the 3 exemplary categories used in the present embodiment (face-to-face, phone or video call, and text message or instant messaging).

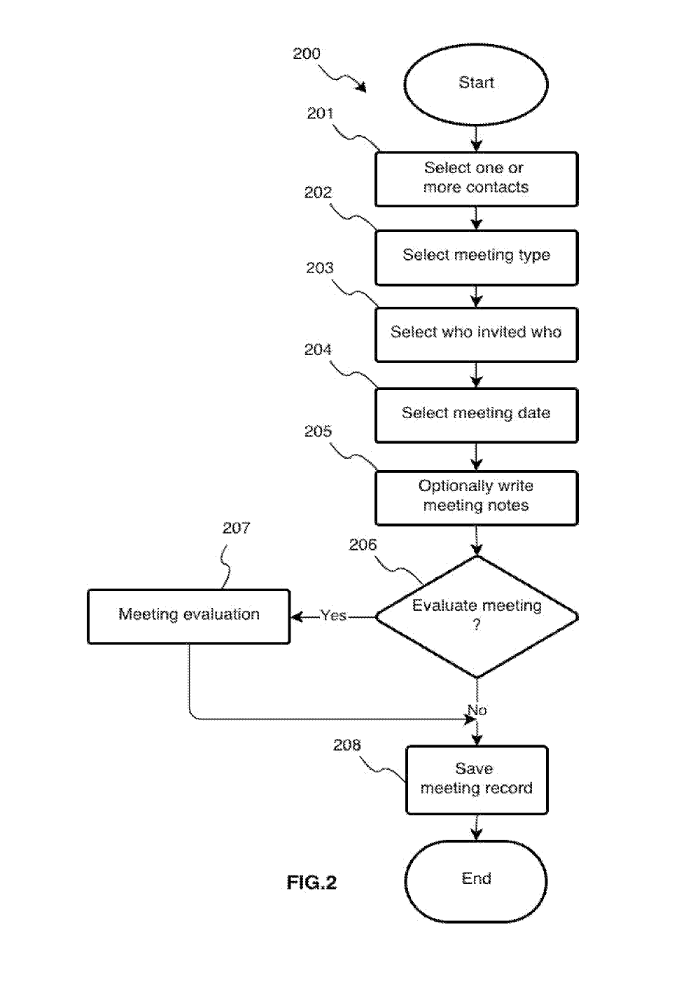

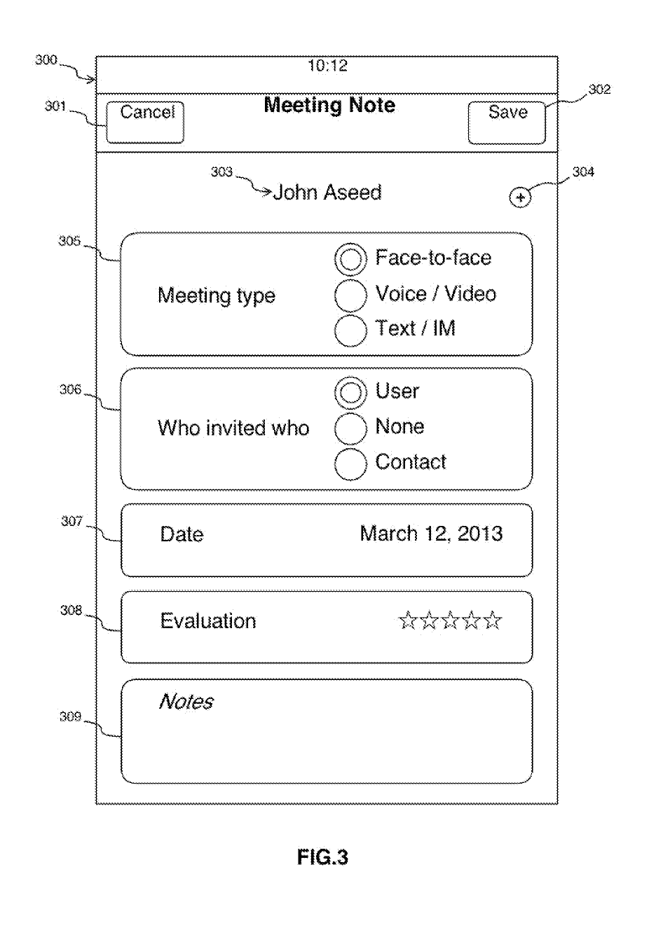

In the present exemplary embodiment, button 107 when pressed may display an interface for recording a meeting note in the system, containing the most relevant information pertaining to a meeting with the contact as described in the process in FIG. 2 and shown in the exemplary interface shown in FIG. 3.

An illustrative description of process 200 of inserting a new meeting note is shown in FIG. 2 in accordance with one embodiment of the invention. In step 201 one or more contacts are selected from the user's list of contacts, these are the contacts participating in the meeting with the user. In the present exemplary embodiment process 200 is initiated by touching button 107 of interface 100 shown in FIG. 1; interface 100 is relative to a contact of the user's contact list which name is shown in label 101, as a consequence the same contact will be used as the first meeting contact in step 201. How to add more contacts will be discussed in the description of FIG. 3 as an example of the present embodiment.

In step 202 the user selects a kind of meeting from a list of possible types. In the present exemplary embodiment the meeting types are: face-to-face, voice (or video) communication and text (any written communication). In step 203 the user must select who invited the other participants to the meeting, if the user has invited the contact then the user may select the option named “User”; if one of the contacts participating in the meeting invited the user then the user may select the option “Contact” or “None” if it is not possible to state one of the two previous selections. In step 204 the user can optionally write notes about the meeting.

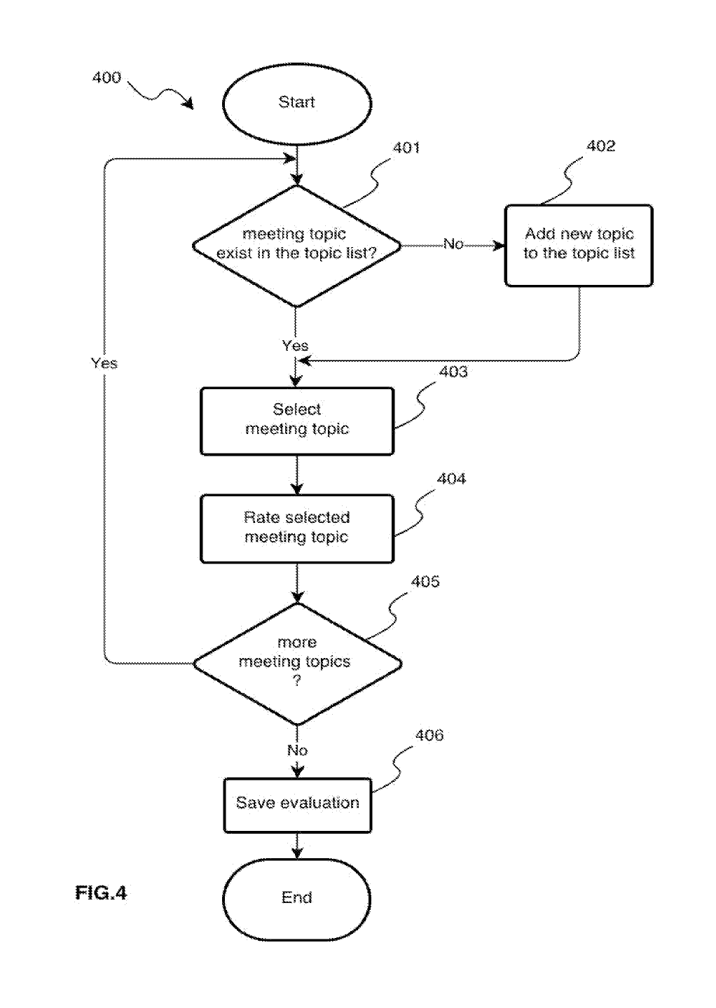

In step 205 the user decides if they wish to insert a meeting evaluation, if the decision is yes then the flow proceeds to step 206 where the user can evaluate the meeting as described in FIG. 4, if the decision is no the meeting note is saved in step 207. The present description of process 200 is illustrative, and alternative implementations can vary for the order of the steps or for the presence of more steps, or for lacking one or more of the above described steps. For example the order of the steps from 201 to 205 can be changed without any significant difference in the outcome of process 200.

FIG. 3 shows a schematic view of an illustrative display of interface 300 that may be used for recording a meeting note from the user with a contact as described by process 200 in accordance with one embodiment of the invention. By touching button 301 the user can cancel the current meeting registration or by touching button 302 the user can save the meeting with the information currently selected and shown by interface 300. In the present exemplary embodiment the user interface 300 is first shown to the user with default values already selected; more specifically contact's name label 303 selected in interface 100 with name of contact 101 before displaying interface 300, the default meeting type selection group 305 value is “face-to-face”, the default inviter selection group 306 value is the user (shown in the interface as “User”), the default meeting date label 307 value is the date of the moment in which user interface 300 is shown to the user and as a default there are no meeting evaluation label 308 and no notes in field 309.

Label 303 displays the name of the meeting contact or a list of contact names in case the meeting was with more people. The user can add more people to the meeting note by touching button 304 which shows the user's contact list from which the user can select more contacts to add to the meeting note. Selection group 305 lets the user select the kind of meeting, in the present exemplary embodiment are shown three kinds of meetings. Selection group 306 is for selecting who invited the other participants to the meeting.

Label 307 shows the meeting date. In the present exemplary embodiment the user may save a meeting that happened before the current date by touching date label 307 and inserting another suitable date (i.e. Today or any date before today).

Label 308 shows a symbolic 5-star representation of a rating of the meeting, which by default is null. In the present exemplary embodiment by touching the 5-star symbol may be shown an interface like that shown in FIG. 4 for example, in which the user may evaluate the meeting. In field 309 the user can write notes about the meeting that are stored with the meeting note.

In other embodiments of the present invention the system can save information about the location of the meeting, the context of the meeting for example a bar or a company or friends house, and other information pertaining to the meeting.

FIG. 4 shows an illustrative flowchart of the algorithm for evaluating a meeting note and for adding new topics to the list of topics defined by the user in accordance with one embodiment of the invention. Process 400 is a detailed specification of step 206 described in FIG. 2 in which the user can record a meeting note, hence in process 400 a specific meeting is being considered by the user for which process 200 specifies its information.

In the present exemplary embodiment the topic list defined by the user is called “value system”. The “value system” represents the list of personal topics that matter to the user, the topics the user likes to talk about or the topics the user values most. Evaluating a meeting against the “value system” is the best way to evaluate the objective value of a meeting for a specific user because if a meeting has a value related to a topic of user's interest then the meeting is valuable to the user and contributes to the value of the relationship of the user with the meeting contact. This kind of relationship evaluation is focused on the objective value perceived by the user during the meetings with a specific contact and the evaluation accumulates meeting after meeting becoming more and more accurate being based on real data. This approach differs from an up front evaluation of a relationship for which the user would be biased by emotional considerations based mainly on the person instead of on the relationship itself.

In the present exemplary embodiment the list of topics defined by the user for the relationships evaluation is called “value system” for emphasizing the personal values of the user, but in a different embodiment, for example targeted to business relationships, the list of topics could be defined by the company the user belongs to or by a set of business related concepts.

In step 401 the user may decide if one of the topics discussed during the meeting is present in the user's topic list, if not in step 402 the user can add the discussed topic to the topic list; if yes in step 403 the user can select the desired topic from the topic list. In step 404 the user must rate the selected topic. The topic rating can be based on a fixed range of numeric values for being stored and statistically elaborated in the relationship evaluation phase described later.

In step 405 the user decides if there are more topics to be rated, if yes it starts again from step 401, if not the evaluation is saved in step 406 in relationship with the current meeting note and the process ends.

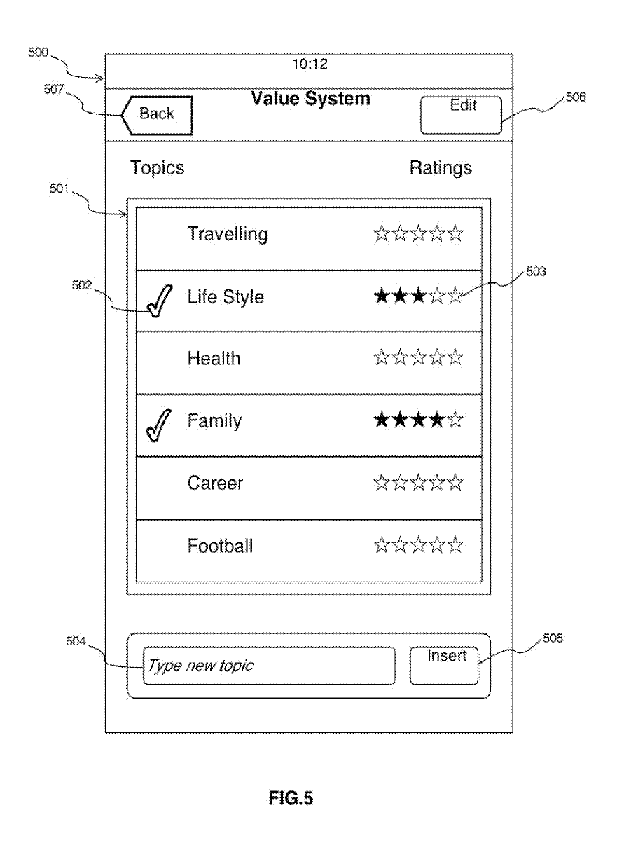

FIG. 5 shows a schematic view of an illustrative display of interface 500 for the evaluation of a meeting as described by the algorithm shown in FIG. 4 in accordance with one embodiment of the invention. Interface 500 may be shown when the user chooses to evaluate the meeting in the process of recording a meeting with a contact by touching label 308. Interface 500 shows the list of topics 501 inserted by the user over time. The list of topics 501 is specific to the user and can be used for every contact and for every meeting evaluation. In the present exemplary embodiment the list of topics 501 is called “value system” of the user; it is the list of subjects that matter to the user.

The user may select one or more topics from list of topics 501 by touching their name on the list of topics 501, when a topic is selected an icon is shown on the left of the topic name 502. For each selected topic the user may rate the meeting experience about the selected topic by touching the 5-star icon 503 next to the selected topic. In the present exemplary embodiment shown in FIG. 5 the user can rate the experience about a topic with a value from 1 star to 5 stars, any other suitable rating system or range values can be applied.

The user may use text box 504 when a new topic is needed in the list of topics 501. In the exemplary embodiment shown in FIG. 5 the user may type the name of the new topic in text box 504 and push button 505 to have the new topic inserted in the list of topics 501. In other embodiments of the present invention new topics may be chosen by the user from a predefined list, which can be synchronized with or updated by a central server. The newly inserted topic will be part of the list of topics 501 for any future meeting evaluation until removed from the list.

In the exemplary embodiment shown in FIG. 5 by pushing button 506 the user can start editing the order of the list of topics 501 or can remove any topic from the same list of topics 501. In the same exemplary embodiment by pushing again button 506 the interface exits from the editing mode. Any other embodiment of the interface or of the interaction would be equally valid for adding, changing the order or removing topics from the list of topics 501.

In the exemplary embodiment shown in FIG. 5, when the user pushes button 507 the topics selection and their ratings are saved as meeting evaluations and the system will return to the interface shown in FIG. 3.

When the meeting note is saved by the user the system saves a new record linked to the specified contact, with all the information entered by the user in the interfaces shown in FIG. 3 and FIG. 5.

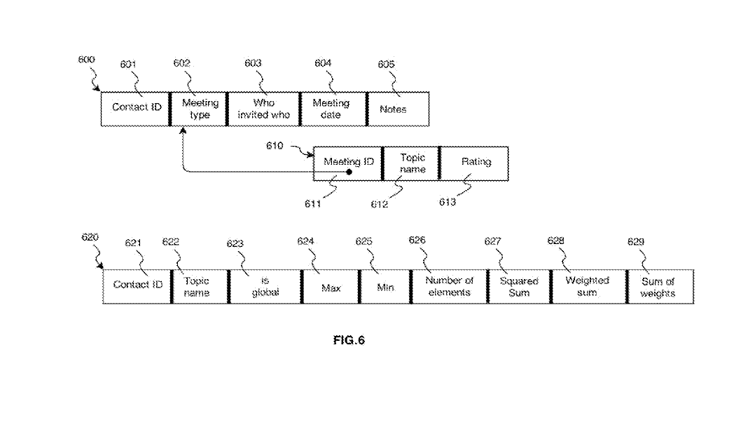

FIG. 6 is an illustrative description of the records needed for saving a meeting note with the evaluations about a specific meeting, and for updating a relationship evaluation in accordance with one embodiment of the invention. More specifically when the user saves a meeting note, the present system creates and stores a new record 600 for it and optionally a set of records 610 are stored and linked to the new record 600 if an evaluation for the recorded meeting is present in the meeting note.

Records 620 contain all information needed for storing and incrementally updating relationship evaluations about contacts on the basis of the information contained in meeting notes, which are stored in records 600 and 610.

Records 600 and 610 may be stored locally on the user's mobile device 702, on the database 708 or in both of them. While records 620 are usually stored on the user's mobile device 702 because they contain the intermediate data to incrementally update relationship evaluation values. While records 800 and 810 contain information about the last value taken by relationship evaluations, which are those shared with other users.

More specifically record 600 contains a contact's identifier contact ID 601 with whom the user met, for a group meeting (i.e. a meeting with more than one contact) multiple record 600 are created. A field that specifies the meeting type 602, a field that specifies who invited who 603 at the meeting, a field for the meeting date 604 and a text field for the meeting notes 605.

For a record 600 about an evaluated meeting there are as many records 610 linked to that record 600 as many topics are part of the evaluation. For example if in a meeting evaluation called X there are 3 evaluated topics (A, B, C) then there will be 3 records 610 linked to the record 600 where the meeting X is recorded. Each record 610 contains a field Meeting ID 611 for linking record 610 to record 600, field with the topic name 612 and field with the evaluation of the topic Rating 613.

Records 600 and 610 are used by the system for showing the user's meeting history in which it is possible to recall all the meetings of the past with specific characteristics. For example the user could find out the meetings held with a specific contact and/or about specific topics or of a particular meeting type or date range. More specifically the system can easily implement statistical functions over the meeting history, for example and not limited to, evaluating meeting frequencies, global average meeting evaluations, topic frequencies and values, etc. These functionalities are particularly useful for evaluating the user's social behavior and skills.

A set of records 620 is associated to each contact with at least one relationship evaluation. The first time the user evaluates a meeting with a specific contact and saves the meeting note associated with it, a relationship evaluation is made by creating a set of records 620 linked to the specific meeting contact by the contact ID 621. This kind of relationship evaluation is incrementally updated every time the user evaluates a new meeting with the same contact, if a new topic is evaluated as part of a new meeting, a new record 620 will be added to the set. More specifically a relationship evaluation consists of a set of topics that is the union of all topics rated over all meeting evaluations with the same contact. Furthermore an additional record 620 is created for incrementally updating the overall contact's relationship evaluation.

The fields that are part of record 620 are topic name 622, a flag in field “is global” 623 for differentiating a topic from the overall evaluation, maximum value in field Max 624 and minimum value in field Min 625, the number of elements 626 of the same topic. The last three fields are those that make possible building iteratively a weighted average rating and the weighted variance for a specific topic.

When a new rating of a topic with name N is added to a contact's relationship as part of a meeting evaluation, the values of the fields 624, 625, 626, 627, 628 and 629 of the record with topic name 622 equal to N and contact ID 621 equal to contact, are updated with the following formulae considering as input the rating value itself (V) and the weight of the rating (W). The rating weight W can be based on several factors, in the present exemplary embodiment a mandatory factor is the meeting type, because a face-to-face meeting has much more importance for a relationship than a phone call, in other embodiment of the present invention another factor could be the social skill rating of the contact at the time of the meeting or the group to which the contact belongs, another example could be the importance the user gives to the contact for social or business reasons at the time of the meeting. Whatever is the set of factors affecting the rating weight, its value is greater than 0 and smaller or equal to 1.

Field Max 624 is updated with the following rule: if value V is greater than the value of field Max 624 then field Max 624 becomes equal to V. Field Min 625 is updated with the following rule: if value V is smaller than the value of field Min 625 then field Min 625 become equal to V. The number of elements 626 value is incremented by one. The weighted sum 628 value is incremented by the value W*V. The weighted squared sum 627 value is incremented by W*V*V. Finally the sum of weights 629 value is incremented by W.

The values of those special records having field “is global” 623 set to the Boolean value true and with contact ID 621 equal to the same contact ID, are updated following the same rules used for the other records (which have field “is global” 623 set to the Boolean value false), for every topic of an evaluation. This record marked as “global” is unique for each contact with at least one meeting evaluation and represent an evaluation over all topics and all meetings given to the contact.

The values recorded in records 620 are necessary for calculating the minimum and maximum value of the evaluations; the weighted average WA is calculated with the formula: weighted sum 628 of all values (SW) divided by the sum of weights 629 (WSUM). The variance can be calculated with the following formula:

$$\sqrt{\frac{\frac{SqSum}{WSUM} - W {A}^{2}}{NE - 1}}$$

Where SqSum is the weighted squared sum 627 of the topic ratings, WA is the weighted average calculated as shown above, WSUM is the sum of weights 629, and NE is the number of ratings for the topic.

The variance of the values is important to show to the user how consistent the evaluation values about a topic are over time. For example if the variance has a low value it means that all evaluations are similar, so the value of the weighted average can be trusted. However, if the variance has a high value it means that evaluations have very different values as a consequence the value of the weighted average is less significant, moreover the minimum and maximum values give an idea of the actual range of the values.

The fields and the values calculated in this description are shown as an example of a possible embodiment. In other embodiments it would be possible to save more values for calculating more statistical information iteratively or not.

FIG. 7 shows a schematic view of an illustrative communication system including two portable electronic devices, a personal computer and a remote server with a database system in accordance with one embodiment of the invention. Communications network 709 may be comprised of any suitable technology, device, system or combination of these for providing wired and/or wireless communications using any suitable short-range or long-range communications protocol such as Ethernet, Wi-Fi (e.g., a 802.11 protocol), radio frequency systems, protocols used by wireless and cellular phones or any other protocol supporting communications between mobile device 702 or personal computer 703 and remote server 706.

Mobile device 702 can be any type of electronic device capable of receiving and transmitting data over the communication links 704 to the communications network 709. Personal computer 703 can be any type of computer of any size and form suitable for personal use. Server 706 can be any kind of computer connected to the communications network 709 or in some embodiments can be comprised of a set of computer possibly geographically distributed connected to the communications network 709.

When the user presses button 104 of FIG. 1 and contact 101 is a user of the present system, universal unique identifiers (UUID) of both the user and contact 101 are exchanged between the user's mobile personal device 701 and the contact's mobile device 702 (or other different devices in different embodiments, for example a personal computer 703). This UUID exchange is made through the communications network 709 the two devices use to connect to remote host 704, or the two mobile devices may exchange the UUIDs over any kind of peer-to-peer connections such as Bluetooth (registered trademark), infrared or other local communication technologies 705 (the same result can be achieved by optical means such as scanning of visual codes such as QRcodes, barcodes or similar technologies). When both mobile devices receive the other party UUID, they may acknowledge the received UUID to the sender and make the association of the UUID with the other party contact by locally saving the contact UUID just joined with the other information pertaining the contact.

When the user's application has a UUID associated with a contact, it means that the user is joined with that contact and the application can start sharing the contact's relationship evaluation. At the end of the joining procedure described above the user and the contact send their mutual relationship evaluations to a remote server 706. Server 706 runs application service 707 that saves the evaluations received from the user's devices in database 708. The schema used to save these evaluation on database 708 is shown in FIG. 8, here can be said that every evaluation in database 708 has a UUID of the evaluator and the UUID of the evaluated contact.

When a relationship evaluation about a joined contact is updated as a consequence of an evaluated meeting, the new values of the evaluation are sent to application service 707, which in turn updates them in database 708.

A user's device may ask to application service 707 the evaluations made by other joined contacts about the user (first case) or about other joined contacts (second case) by requesting to application service 707 all the evaluations with an evaluated UUID equal to the user's UUID in the first case or equal to the joined contact UUID in the second case.

When a user wants to stop being joined to a contact by pressing button 104 (“Joined”) shown in FIG. 1, the device asks application service 707 to delete the evaluation in database 708 with the user's UUID as evaluator UUID 802 and with the contact's UUID as evaluated UUID 801.

FIG. 8 shows an illustrative schematic logical description of a subset of database 708 shown in FIG. 7 used for storing relationship evaluations in accordance with one embodiment of the invention. For each relationship evaluation for a contact, which has unique identifier ContactUUID, made by the user, which has unique identifier UserUUID, application service 707 stores in database 708 a record 800 with the following fields: evaluated UUID 801 containing the ContactUUID, evaluator UUID 802 containing the UserUUID, the date last update 803, a flag anonymous 804 showing if the evaluation is anonymous and published evaluator name 805, that can contain the name of the user if the evaluation is not anonymous or null if it is anonymous.

For every evaluation application service 707 will store a set of records 810 containing the topics of the evaluation (plus one record for the general evaluation) linked to record 800 through link to evaluation 811.

Each record 810 contains the following fields: topic name 812, topic maximum value Max 813, topic minimum value Min 814, the number of elements 815 in this topic evaluation, the weighted variance 816 of the values of this topic, and the value of the weighted average 817.

When a user wants to know the evaluation made by other users about a user's contact which in this exemplary embodiment are called references, then the user's device will send to application service 707 a request for returning all records 800 and all linked records 810, which evaluated UUID 801 is equal to the user's contact UUID and evaluator UUID 802 is different from the user UUID.

As another example when the user wants to see all the evaluations made by other contacts about his or herself then the user's device will send to application service 707 a request for returning all records 800 and all linked records 810, which evaluated UUID 801 is equal to the user's UUID.

When a user disconnects from a contact (i.e. when a user stops being joined to a contact it is said that the user unjoins from the contact) the user's device will send a request to application service 707 to delete all records 800 and all linked records 810 with evaluated UUID 801 equal to the contact UUID and evaluator UUID 802 equal to the user's UUID. In another embodiment of the present invention the unjoin action would not remove any record from database 708 but it would set a flag in the records 800 to be unjoined.

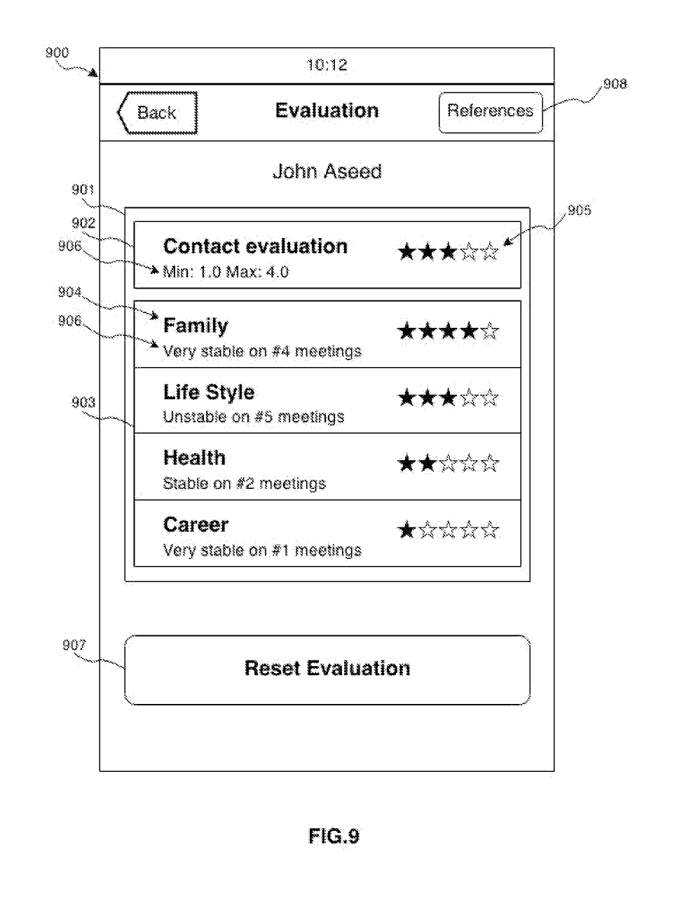

FIG. 9 shows a schematic view of an illustrative display of interface 900 showing an evaluation about a relationship in accordance with one embodiment of the invention. In the present exemplary embodiment interface 900 is displayed when the user presses button 105 shown in FIG. 1 of interface 100 referred to a specific user's contact 101.

The relationship evaluation is shown in box 901, it contains a list of ratings generally comprised of a general contact evaluation 902, shown at the top of the list, followed by a variable-length list of topic evaluations 903. In the exemplary present embodiment each evaluation is shown as a topic name 904 (or the general evaluation), a 5-star rating 905, and below topic name 904 a set of statistical information 906 about the evaluation, as an example they could be minimum and maximum value or an indicative value for the variance of the evaluations or the number of evaluations for topic name 904. In other embodiments the above information could be shown with numeric values or with descriptive icons or in other graphic or numeric forms.

Button 907 lets the user reset the evaluations made thus far after a confirmation question. This action deletes all records 620 with a contact ID 621 equal to that of the present contact, removing the evaluation history but not necessarily every evaluation recorded inside the contact meeting evaluation records 600 and 610, that can still preserve the history of the meeting evaluations without being part anymore of the relationship evaluation.

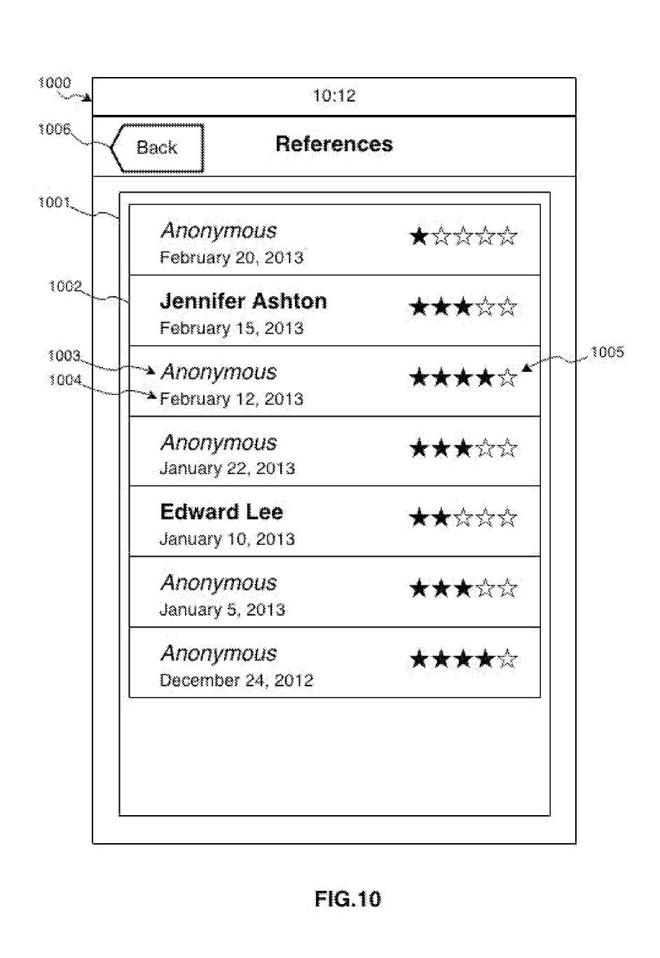

Button 908 is active when the contact of the evaluation shown in interface 900 is joined to the user. By pressing button 908 the system will show the evaluation list made by other users about the contact, which user's evaluation is shown in interface 900, as shown in FIG. 10.

FIG. 10 shows a schematic view of an illustrative display of interface 1000 for showing the list of all evaluations made by other users about a user's contact in accordance with one embodiment of the invention. The following description applies equally to the evaluations made by other contacts about the user even if not explicitly stated.

List 1001 shows all the evaluations regarding a specific user's contact, every evaluation is represented in list 1001 by a box 1002 containing the name of contact 1003 who made the evaluation or “Anonymous” in case the contact doesn't want to disclose their name, the date of the last evaluation update 1004 and the overall evaluation 5-star rating 1005. As an enforcement of the users' privacy in the present exemplary embodiment, the date of the last evaluation update 1004 and the value of the overall evaluation 5-star rating 1005 of anonymous evaluations are visible only if the list contains more than a prefixed number of anonymous evaluations MinEval (for example MinEval in the exemplary embodiment has a value of 4). Non-anonymous evaluations are always visible.

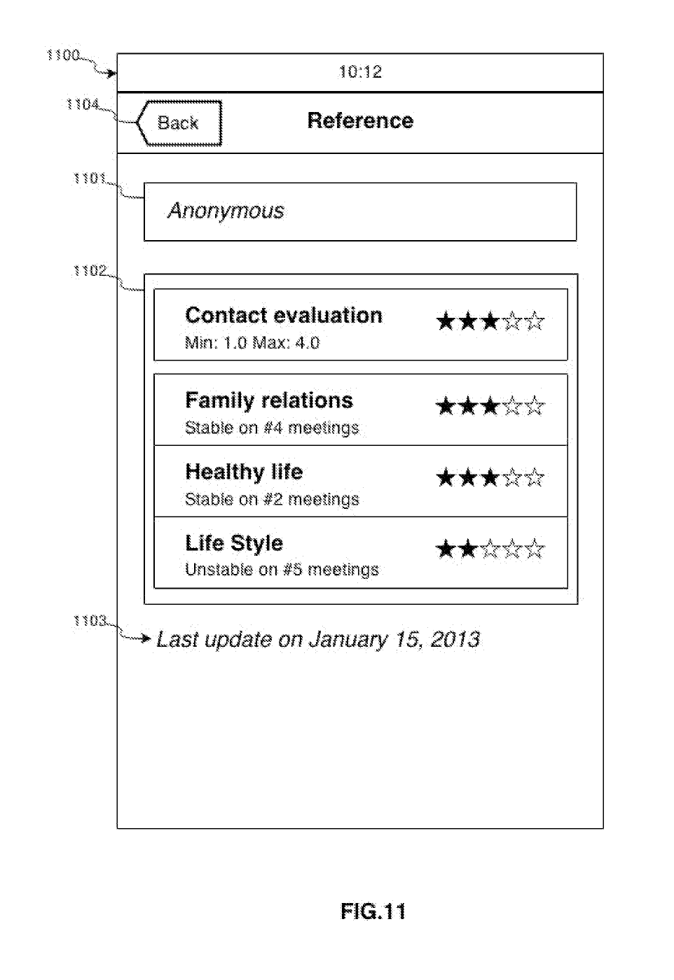

When the user touches one of the boxes 1002 of the list 1001 the system shows the details of the relative evaluation as showed in FIG. 11.

Button 1006 lets the user return to interface 900.

FIG. 11 shows a schematic view of interface 1100 showing the details of an evaluation made by other users about a user's contact in accordance with one embodiment of the invention. The following description applies equally to the evaluations made by other contacts about the user even if not explicitly stated.

In box 1101 is shown the name of the evaluator or “Anonymous” if the contact that made the evaluations doesn't want to disclose his or her name. Box 1102 has the same structure and information of box 901 shown in FIG. 9 because both boxes show an evaluation.

Label 1103 shows the date of the last update of the evaluation.

Button 1104 lets the user go back to the previous interface 1000.

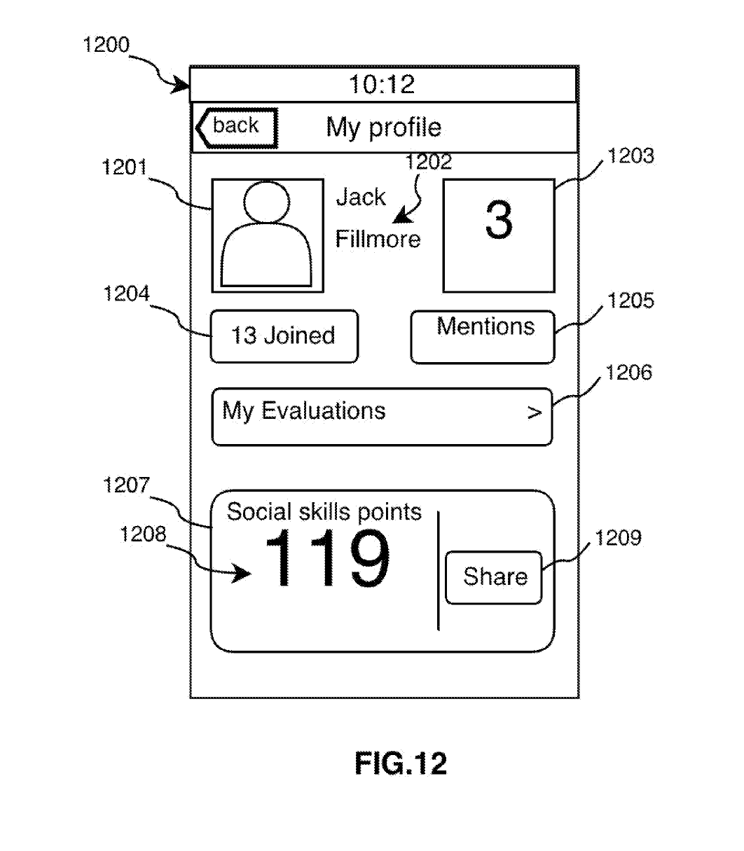

FIG. 12 shows a schematic view of an illustrative display of interface 1200 that may be used for showing the overview of the user's relationships and a rating of the user's social skills in accordance with one embodiment of the invention.

Box 1201 contains a picture of the user, label 1202 shows the user's name, and box 1203 shows the average balance of all the user's relationships with the same metaphor shown in icon 103 of FIG. 1.

Box 1204 shows how many contacts are joined with the user or the label “No joins” if none. Button 1205 is active only if the user has one or more contacts joined, when button 1205 is active and is pressed by the user, the system shows an interface with the list of other contact's evaluations about the user as shown in FIG. 10. When button 1206 is pressed, the system shows an interface similar to interface 900 shown in FIG. 9 in which instead of a specific contact evaluation such as in FIG. 9, it is shown the average of all the evaluations made for all the user's contacts. The only difference with FIG. 9 will be the lack of the contact's name.

Box 1207 contains a label 1208 showing a rating calculated by the system of the social skills of the user and a button 1209 with which the user can post on social networks of which they are members, a message stating that the user's social skill rating is the value present in label 1208. The specific mechanism for posting messages on actual social networks is usually implemented as public APIs or SDKs by each social network and it is beyond the specifications of the present invention.

The evaluation of the social skill rating shown in label 1208 is elaborated on the basis of the following factors related to the user's meeting activity in a specific timeframe: number of joined contacts (JC), number of meetings (NM), number of contacts met (CM), number of meetings evaluated (ME), number of meetings with joined contacts (JM); while the following criteria are not based on the meeting history but at the time of the rating valuation: total number of topics in all references by contacts (NT), number of contacts with a reference for the user (NCM), average reference overall value for the user (AMV). The first group of parameters, which are time dependent, are combined and weighted on several adjacent timeframes with descending weights, from the timeframe on which the rating is valued to the more distant timeframes of the past. For example if the combined group of parameter is called Xval, the time dependant part of the rating RT could be valued as the following sum RT:

$$RT = {\sum }_{T = 1}^{x} {Xval}_{T} * {W}_{T}$$

where T are the timeframes taken into consideration. Those timeframes can be overlapped or not and can be chosen arbitrarily, weights WT are weights with descending values and XvalT are the combined paramenters Xval at the timeframe T. In the present exemplary embodiment T1 may be the month in which the rating is valued, T2 the previous month, T3 is the month before T2 and so on until T12, which is a month one year before T1 and weights WT have descending values from W1=2.0 to W12=1.0. The value of the time dependent rating RT is added to the combination of the remaining parameters not time-dependent RNT (i.e. NT, NCM, AMV) for evaluating rating R which is displayed on label 1208.

The user is encouraged to improve the value R displayed on label 1208 as a consequence of the improved relationships. The system displays periodically (on a pop-up window for example or on another specific area of the system visible to the user) advice on how to improve the relationships by encouraging the improvement of the value of one or more parameters of those used in the rating R displayed on label 1208. The system can gather average ranges of those values from the users to encourage the users with values below those ranges to improve specific values. For example if the average value of joined contacts JM for all users is 9.8, those users with value of JM below 9.8 may periodically receive a message that asks the user to join more contacts.

Another kind of advice the system is able to give to users is based on the comparison between shared evaluations stored on database 708 and exposed to the user's devices by application service 707. As mentioned above, the evaluations stored in database 708 may have a structure similar to records 800 and 810 shown in FIG. 8.

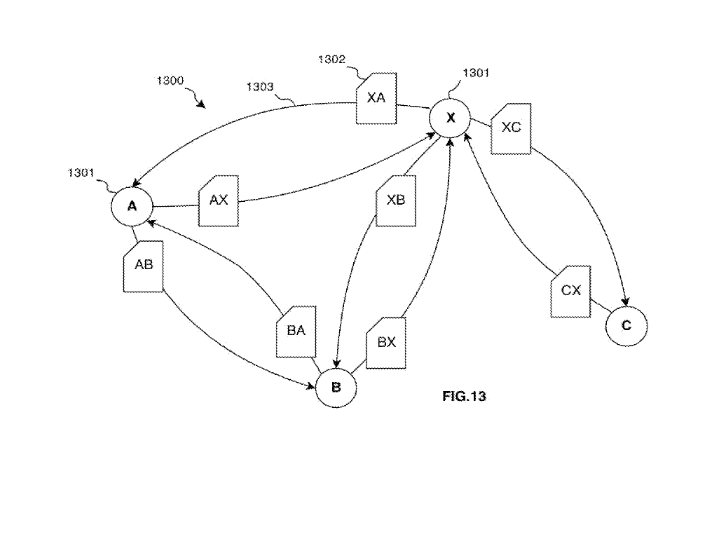

FIG. 13 shows an example of an illustrative directed graph including nodes representing users and directed arcs representing evaluations in accordance with one embodiment of the invention. Considering evaluated UUID 801 and evaluator UUID 802 contain users' unique identifiers UUID, each user is represented on graph 1300 as a node 1301 whose value is a UUID. Moreover every record 800, with its associated records 810, can be considered a directed arc 1303 between node 1301 with evaluator UUID 802 and another node 1301 with evaluated UUID 801. More precisely all records 810 associated with a record 800, which is represented on graph 1300 as an arc 1303, containing the evaluation 1302 of the relationship between the evaluator-user with evaluator UUID 802 and the evaluated-user with evaluated UUID 801.

Analyzing graph 1300, from the perspective of the user represented with node 1301 with identifier X (which we will call user X), gives important information on how user X is interacting with other users. The results of this analysis are used by the present system to give advice to users for improving their social skills. The following examples are possible conditions that can be found during the graph analysis of graph 1300 shown in FIG. 13, with possible advice for users. If topic T1 has a value below a specific threshold value in most of the evaluations AX, BX and CX (that are the evaluations made by users A, B and C of the relationships with user X), then the system may give the advice to the user X to improve the way topic T1 is discussed in meetings. If the topic T2 has a value above a specific threshold value in most of the evaluations AX, BX and CX, then the system may send a notification to all users connected to X that X is an expert about topic T2. If topic T3 has a value below a specific threshold value in evaluation XA, but T1 has a high value in XB and XC, then the system may give the advice to user A to improve the way topic T3 is discussed with X. If topic T4 is part of the evaluation XC and of the value system of user A but the same topic T4 is not part of the evaluations AX and XA, then the system may give the advice to users X and A to talk about T4 in their meetings. If topic T5 has a value above a specific threshold value in the evaluations XA and BA and user C has T5 in the value system, then the system may give the advice to user X to introduce A to C because of their common interest in T5. The above examples are only a small subset of the many possible analysis that can be executed on the evaluations graph 1300.

Embodiments of the present invention may include various steps as set forth above. The steps may be embodied in machine-executable instructions, which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable program code. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic program code.

Throughout the foregoing description, for the purposes of explanation, numerous specific details were set forth in order to provide a thorough understanding of the invention. It will be apparent, however, to one skilled in the art that the invention may be practiced without some of these specific details. For example, it will be readily apparent to those of skill in the art that the functional modules and methods described herein may be implemented as software, hardware or any combination thereof. Moreover, although embodiments of the invention are described herein within the context of a mobile computing environment (i.e., using mobile devices 702 or personal computer 703), the underlying principles of the invention are not limited to a mobile computing implementation. Virtually any type of client or peer data processing devices may be used including, for example, desktop or workstation computers.

What is claimed is:

1) A method of evaluating relationships among contacts of a user on a portable electronic device, the method comprising:
a. determining whether a topic during a meeting with a contact is a topic among a list of topics to be rated;
b. selecting the topic from the list to be rated if the topic during the meeting is on the topic list, otherwise adding the topic during the meeting to the topic list and then selecting the topic to be rated;
c. rating the selected topic;
d. repeating operations a-c until each topic to be rated during the meeting has been rated; and
e. storing the ratings as a current meeting evaluation.

2) The method of claim 1, wherein the rating of the selected topic is performed by inputting a rating value and a weight of the rating.

3) The method of claim 2, wherein a weighted average (WA) is calculated by dividing the weighted sum of all values by the sum of rating weights (WSUM).

4) The method of claim 3, wherein a stability of the evaluation values about a topic is determined by the following equation:
$$\sqrt{\frac{\frac{SqSum}{WSUM} - W {A}^{2}}{NE - 1}}$$
wherein SqSum is the squared weighted sum of the topic ratings, WA is the weighted average calculated, WSUM is the sum of the rating weights, and NE is the number of ratings for the topic.

5) The method of claim 2, wherein the rating weight is based upon factors including: a) meeting type, b) social skill rating of the contact at the time of meeting, c) the group at which the contact belongs, and d) the importance given to the contact regarding social or business reasons at time of meeting.

6) The method of claim 5, wherein the meeting type comprises one of a face-to-face meeting or a telephone meeting.

7) The method of claim 1, further comprising:
for each evaluation performed by the user, storing in a database a record including a) an evaluated contact UUID field, b) an evaluator user UUID field, c) the date of the last update, d) a flag showing whether the evaluation is anonymous, and e) the published name and the name of the user if the evaluation is not anonymous.

8) The method of claim 7, further comprising:
for each evaluation performed by the user, storing in a server a set of records containing the topics of the evaluation line to the record stored in the database through a link between the database and the server.

9) The method of claim 8, wherein the each record stored in the server contains a) the topic name, b) a maximum value, a minimum value, c) the number of evaluations with the respective topic, d) the weighted variance of the values of the respective topic, and e) the weighted average value.

10) The method of claim 9, further comprising:
determining an evaluation made by another user about the user's contact by sending to the server a request for returning all records stored in the database and all link records stored in the server, in which the evaluated contact field UUID is equal to the user's contact field UUID and the evaluator UUID is different from the user UUID.

11) The method of claim 9, further comprising:
determining all evaluations made by other contacts about the user by sending to the server a request for returning all records stored in the database and all linked records stored in the server, in which the evaluated contact field UUID is equal to the user's UUID.

12) A mobile electronic evaluation device to wirelessly connect with other mobile electronic evaluation devices, comprising:
an interface including:
a section to display a name of a contact being evaluated;
a relationship evaluation section containing a list of ratings including:
a general contact evaluation including a five star rating and statistical information about the contact evaluation, and
a variable-length list of topic evaluations below the general contact evaluation and including a set of statistical information about the evaluation;
a reset button to provide for a user to reset the evaluations made to date after a confirmation question; and
a references button which allows the user to view an evaluation list made by other users about the contact which the user's evaluation is shown in the interface.

13) The mobile electronic device of claim 12, wherein each topic evaluation is illustrated as a topic name including a five star rating and statistical information about the evaluation.

14) The mobile electronic device of claim 12, further comprising:
a join button which begins a joining procedure to join a contact to be evaluated through an internet connection, a communications network, or peer-to peer connection.

15) The mobile electronic device of claim 12, wherein the interface further comprises:
a label to display a rating of the social skills of the user received externally; and
a button in which the user presses to post on a social network including other users, a message stating that the user's social skill rating is the value presented in the label.

16) A relationship evaluation communication system, comprising:
at least one mobile electronic evaluation device;
a communications network to provide exchanging of universal unique identifiers (UUID) between a user of either the at least one of the mobile electronic evaluation devices and a contact to be evaluated at another one of the mobile electronic evaluation devices to make a connection for relationship evaluations; and
a remote server including a database system to receive relationship evaluations from the user and the contact once the connection therebetween is complete, to run a service application which saves the evaluations received in a database, and to receive updated relationship evaluation values as a result of each additional meeting between the user and contact and to send the updated evaluation to a service application provided therein, and to update the values in the database.

17) The system of claim 16, wherein for each evaluation by a user for a contact, the server application stores in the database a record with the following fields: an evaluated unique identifier (UUID) containing the contact UUID, the evaluator UUID containing the user UUID, the date of the last update, a flag showing whether the evaluation is anonymous and the published name with the name of the user if the evaluation is not anonymous or null if anonymous.

18) The system of claim 17, wherein for each evaluation the server stores a set of records therein containing the topics of the evaluation linked to the record stored in the database through a link between the server and the database.

19) The system of claim 18, wherein each record stored in the server contains the following fields: a topic name, a maximum value, a minimum value, the number of evaluations with the respective topic, a weighted variance of the values of the respective topic and a weighted average value.

20) The system of claim 19, wherein the at least one mobile electronic evaluation device sends a request to the server to return all records of the database and all linked records of the server, in which the evaluated UUID field is equal to the user's contact UUID and the evaluator UUID is different from the user UUID in order to receive an evaluation made by another user about the user's contact from the server.

21) The system of claim 18, wherein the at least one mobile electronic evaluation device sends a request to the server to return all records of the database and all linked records of the server, in which the evaluated UUID field is equal to the user's UUID in order to receive all evaluations made by other contacts about the user from the server.

22) The system of claim 20, wherein when one of the at least one mobile electronic evaluation device of another user is disconnected from a contact device, the user's mobile electronic evaluation device sends a request to the server to delete, or mark as deleted, all records in the database and all linked records in the server with the evaluated UUID field equal to the contact UUID and the evaluator UUID equal to the user's UUID.

23) The system of claim 15, wherein one or more of the at least one mobile electronic evaluation device is a personal computer.

23) The system of claim 15, wherein one or more of the at least one mobile electronic evaluation device is a mobile phone.

24) The system of claim 15, wherein the at least one mobile electronic evaluation device comprises an interface to show an overview of the user's relationships and a rating of the user's social skills.

25) The system of claim 24, wherein the interface comprises:
a label displaying a rating calculated and received by the database system; and
a button in which the user presses to post on a social network including other users, a message stating that the user's social skill rating is the value presented in the label.

26) The system of claim 24, wherein the evaluation of the social skill rating of the user is calculated based on at least one of the following factors: a) the user's meeting activity in a specific timeframe: b) number of joined contacts (JC), c) number of meetings (NM), d) number of contacts met (CM), e) number of meetings evaluated (ME), f) number of meetings with joined contacts (JM); g) total number of topics in all references by contacts (NT), h) number of contacts with a reference for the user (NCM), and i) the average reference overall value for the user (AMV).
